(19) United States
(12) Patent Application Publication
(10) Pub. No.: US 2015/0051860 A1
(43) Pub. Date: Feb. 19, 2015

(54) AUTOMATIC OPTICAL APPEARANCE INSPECTION BY LINE SCAN APPARATUS

(71) Applicant: Taiwan Semiconductor Manufacturing Co., Ltd., Hsin-Chu (TW)

(72) Inventors: Kewei ZUO, Xinbei City (TW); Wen-Yao CHANG, Hsinchu City (TW); Ming-Shin SU, Kaohsiung City (TW); Chien Rhone WANG, Hsin Chu (TW); Hsin-Hui LEE, Kaohsiung (TW); Chih-Hao LIN, Hsinchu City (TW)

(73) Assignee: Taiwan Semiconductor Manufacturing Co., Ltd., Hsin-Chu (TW)

(21) Appl. No.: 13/969,630

(22) Filed: Aug. 19, 2013

(51) Int. Cl. G07C 3/14

(52) U.S. Cl. CPC G07C 3/14
USPC 702/82

(57) ABSTRACT

A method of inspecting a structure of a device and a system for doing the same is described. The method includes generating a sample image of a device having a structure to be inspected; identifying a plurality of features of the sample image; comparing the plurality of features to a corresponding plurality of features of a reference image; and locating features in the sample image that deviate from corresponding features of the reference image. The generating step includes moving the device, a detector array or both, relative to one another, wherein the detector array is configured to generate a line of data representing light reflected from the device, and assembling lines of data from the detector array to generate a sample image.

### TECHNICAL FIELD

The disclosure relates to devices and methods for automatic optical appearance inspection by a line scan apparatus, such as a linear array detector.

### BACKGROUND

Modern assembly line manufacturing processes are typically highly automated in terms of operations to manipulate materials and devices in order to create a finished product. Quality control processes often rely on human skill, knowledge and expertise for inspection of the manufactured product both during manufacture and as a finished product, detection of defects, and evaluation and correction of manufacturing processes that cause defects, among others.

Current assembly line processes employ inspection techniques that rely on manual analysis by one or more engineers and/or assembly line operators. Such techniques require large amounts of overhead and expensive hardware, but still fail to produce satisfactory results.

### BRIEF DESCRIPTION OF THE DRAWING

The present disclosure is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is a schematic diagram of an embodiment of a system for automatic online inspection of devices;

FIG. 2 is a flowchart of an embodiment of a method of automatic online inspection of devices;

FIGS. 3A and 3B are images showing a printed circuit board and the same printed circuit board with boxes highlighting areas with abnormal features (or defects), respectively, of a type that can be detected by the embodiment of FIG. 1;

FIGS. 4A and 4B are images showing a ball grid array and the same ball grid array with boxes highlighting areas with abnormal features (or defects), respectively, of a type that can be detected by the embodiment of FIG. 1;

FIG. 5 is a variety of images showing various ball defects in a ball grid array, of types that can be detected by the embodiment of FIG. 1;

FIG. 6 is a variety of images showing various substrate defects in a ball grid array, of types that can be detected by the embodiment of FIG. 1; and

FIG. 7A is a chart showing image detail (measured by μm/pixel) versus field of view for an AAC device, and FIG. 7B is a chart showing image detail (measured by μm/pixel) versus field of view for a LAC device according to the embodiment of FIG. 1.

### DETAILED DESCRIPTION

This disclosure in various embodiments provides devices and methods for automatic online optical inspection of devices, such as semiconductor devices and advanced semiconductor packages. Current techniques are heavily reliant on human intervention, which creates significant bottlenecks in the manufacturing process. In contrast to an area array CCD device (i.e., a 2D camera), the systems described herein can provide much improved accuracy (or detail) and increased throughput, while also simplifying the inspection system and reducing the amount of operator intervention.

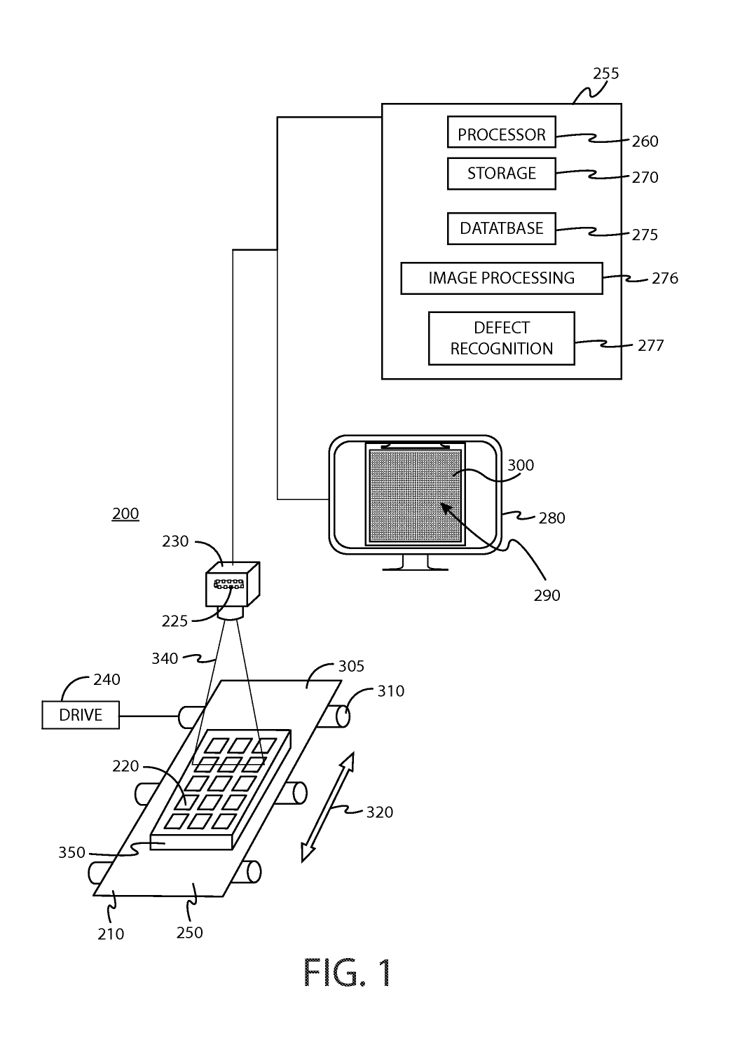

FIG. 1 is a schematic diagram of an inspection system 200 according to some embodiments.

In some embodiments, a quality assurance system 200 for inspection of devices is provided. The system 200 includes a stage 210 or movable fixture for supporting a device 220 being inspected. A linear array detector 230 is spaced apart from the stage 210. In some embodiments, an endless conveyor 305 having a drive 240 is provided for moving a surface 250 of the stage 210 longitudinally relative to the linear array detector 230. In other embodiments (not shown), the stage is stationary, and the drive 240 moves the linear array detector 230 longitudinally relative to the surface of the stage 210. In other embodiments (not shown), a plurality of drives move surface 250 of the stage 210 and the linear array detector 230 independently.

The linear array detector 230 is positioned above the stage 210 in some embodiments. The system 200 also includes a processing device 255, including a processor 260, operatively connected to the linear array detector 230. In some embodiments, the processor 260 is programmed to carry out any of the methods described herein and can be operatively connected to a computer readable storage 270, a display 280, or both. In some embodiments, the non-transitory computer readable storage medium 270 includes a database 275 that stores the reference image, calibration image, defect detection parameters, and any other information for completing the inspection methods described herein. In some embodiments, the processing device 255 is a computer that includes processor 260, computer readable storage medium 270, database 275, image processing logic 276 and defect recognition logic 277.

The system 200 includes a sample stage 210 for positioning a device 220 for inspection. In some embodiments, the stage 210 is part of an endless conveyor 305 supported by a plurality of rollers 310. As shown in FIG. 1, in some embodiments, the stage 210 is a continuous belt of the conveyor 305. A drive 240 is provided to move the conveyor belt on a continuous path around the rollers 310. In some embodiments, the drive 240 is operated automatically by the processor 260. In other embodiments, the drive 240 is operated manually. In other embodiments, the stage 210 is a separate fixture placed on the conveyor 305 for holding the device 220 within the field of view of an inspection device, which can be a line array detector 230.

In some embodiments, a plurality of devices 220 are placed on the conveyor 305 to be inspected together. For example, as shown in FIG. 1, a plurality of devices 220 can be placed in a sample carrier 350, tray, or boat, which is supported on the stage 210. The sample carrier 350 is adapted for receiving one or more rows (lateral, or cross, direction) and one or more columns (longitudinal, or machine, direction) of samples 220 in a predetermined arrangement.

As used herein, “detector array” includes linear array detectors. Further, the term “linear array detector” includes digital line-scan cameras and sensors having one or more rows of pixels for RGB color, or one or more rows of sensing elements for monochrome images arranged in rows. In some multi-row embodiments, the linear array detector includes fewer than ten rows or pixels or sensing elements. In some embodiments, each pixel has a plurality of sensing elements (e.g., charge-coupled device (CCD), back-side illuminated (BSI) type detector, or CMOS imaging sensor) with respective red, green and blue filters, for RGB sensing. In some embodiments, for an RGB linear array detector, each pixel includes two detecting elements with green filters, one detecting element with a blue filter and one detecting element with a red filter, arranged in a Bayer pattern. A variety of alternative color filter arrangements can be used to compliment a particular embodiment. In other embodiments, each pixel is one luminance sensing element for monochrome imaging.

In some embodiments, the array of detecting elements 225 of the linear array detector 230 is oriented so that a line of sight between the line array and the stage 210 is perpendicular to the direction of motion 320 of the stage in some embodiments. This is shown in FIG. 1 by the field of view 340 of the linear array detector 230, which extends perpendicular to the stage motion 320.

In some embodiments, the detecting elements 225 of the line array detector 230 is oriented at an angle of greater than 10° relative to the longitudinal axis of the linear array detector 230. In some embodiments, a line array of detector elements of the linear array detector 230 is be arranged generally perpendicular to the longitudinal direction. As used herein, “generally perpendicular” refers to perpendicular and minor deviations therefrom (e.g., 15° or less, or 10° or less, or 5° or less, or 1° or less).

In some embodiments, the linear array detector 230 is pivotally mounted and controllably rotated by a servomechanism. In some embodiments, the processor 260 commands the line array detector 230 to pivot so that the field of view 340 of the detector 230 sweeps across the device being inspected 220. In embodiments where the movement of the line array detector performs the scanning function, the stage 210 can remain stationary during imaging.

At least one processor 260 is provided. In some embodiments, a single processor 260 (i) controls the drive 240 to move one of the stage 210 or the linear array detector 230 with respect to the other of the stage 210 or the linear array detector 230, (ii) controls the linear array detector 230 to collect image data, and (iii) performs image processing and detect recognition (in image processing module 276 and defect recognition module 277, respectively). In other embodiments, these tasks are allocated to two or more processors. For example, in some embodiments, the control functions for moving the conveyor 305 and collecting image data are allocated to a first processor, and the image processing and detection recognition tasks are allocated to a second processor, etc.

In some embodiments, the processor 260 is programmed to generate a sample image 290 of a device 220 on the stage 210 from lines of data collected by the linear array detector 230; compare a plurality of features 300 of the sample image 290 to a corresponding plurality of features of a reference image (not shown); and locate “abnormal” features in the sample image (i.e., features of the sample image which deviate from corresponding features of the reference image by a threshold amount or threshold number of standard deviations).

In some embodiments, the processing device 255 includes image processing circuitry 276 for creating an output image using a sample image 290. In some embodiments, the image processing circuitry 276 is provided by programming a general purpose processor to configure the logic circuits of the processor 260 as a special purpose image processor. The image processing circuitry 276 integrates successively collected lines of image data from the linear array detector 230 to form a rectangular array of image data. The array of image data is processed to generate the sample image. Image processing algorithms useful for digital image processing can be used. For example, in some embodiments, the image processing algorithms perform noise removal, defective pixel correction, dark current correction, color interpolation and correction, white balance correction, or a combination thereof.

In some embodiments, a defect recognition module 277 performs one or more comparisons between characteristics or features of a sample image constructed from data collected by the linear array detector 230 and a reference image. The defect recognition module 277 applies decision rules to determine whether detected differences between the sample image and the reference image are acceptable, or rise to the level of being characterized as “abnormal” or “defective”.

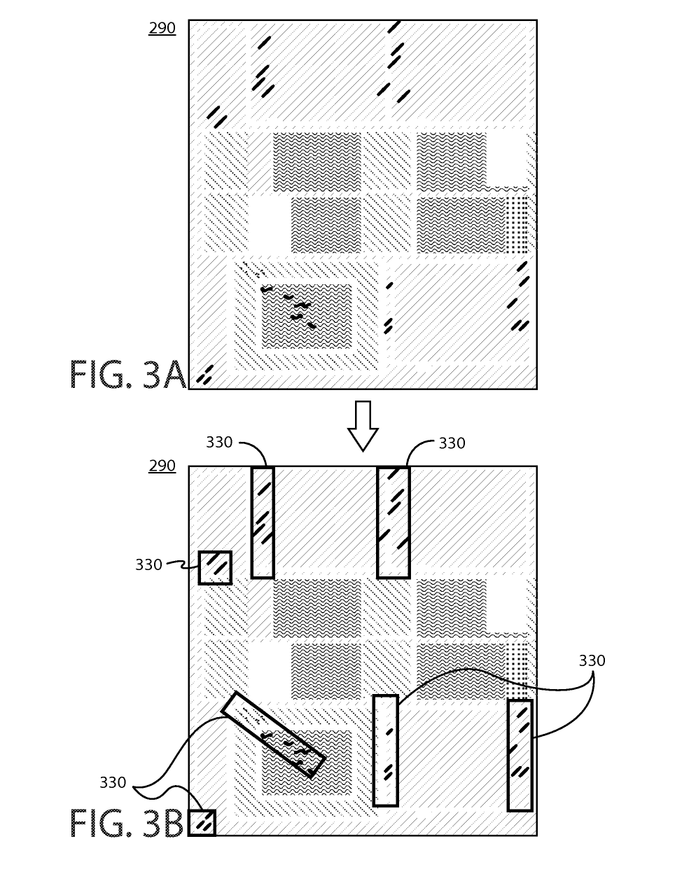

The system 200 further comprises a display device 280, including, but not limited to, a monitor, a laptop computer, a tablet, or a mobile device, etc. In some embodiments, the defect recognition module 277 includes a graphical user interface for displaying the sample image. In some embodiments, the sample image is displayed alone. In other embodiments, the sample image is juxtaposed with the reference image. As discussed in the description of FIG. 3B, the displayed sample image can include highlights around areas 330 identified by the image processing circuitry 276 as containing a defect in order to assist the user in finding the locations of the defects.

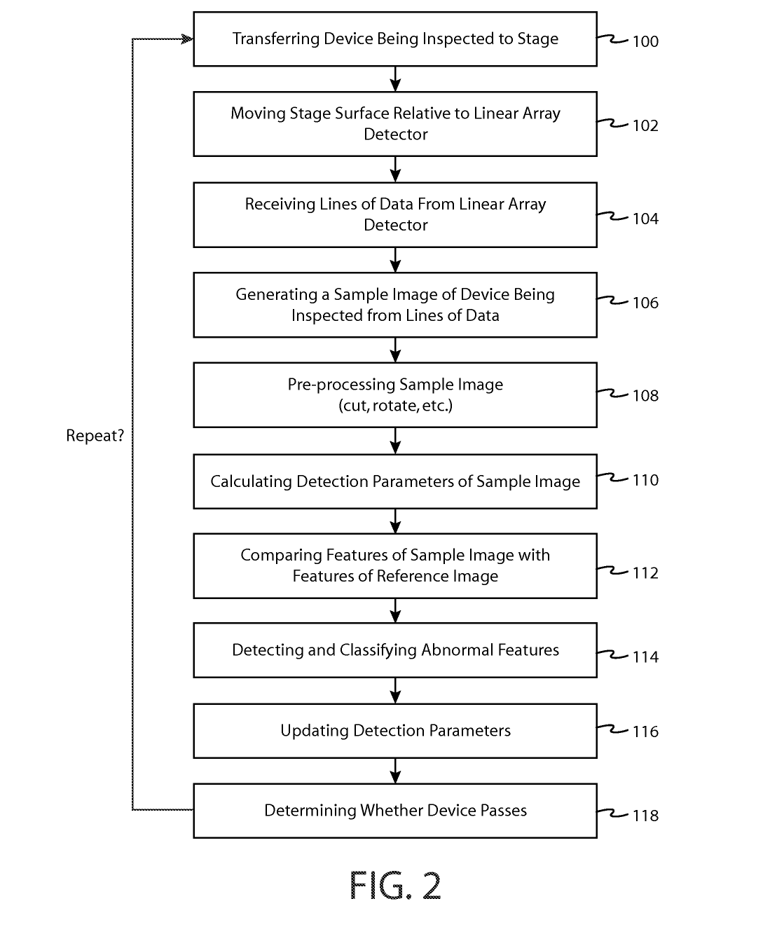

In some embodiments, the system 200 is adapted for carrying out a method described below. An overview of the method used to inspect semiconductor devices is provided in FIG. 2. Further details of the method and structures formed according to the methods are provided in conjunction with the subsequent figures.

In accordance with some embodiments, FIG. 2 is a flowchart describing a method for inspecting a device having a plurality of features.

At step 100, a device 220 being inspected is transferred to a stage 210 for supporting the device 220 being inspected. In some embodiments, the device 220 is an individual device, while the device can be a full lot of devices in other embodiments. The individual devices 220, or the lot of devices can be logged by the processor 260 and recorded in a database 275 for tracking and quality control purposes.

At step 102 the stage 210 is moved relative to a linear array detector 230 (or the detector is moved relative to the stage). The term “relative movement” refers to either of the stage 220 or the linear array detector 230 moving relative to the other one of the stage 220 and the linear array detector 230. Thus, relative movement encompasses linear movement of the stage 210, linear movement of the linear array detector 230, or rotation of the linear array detector 230 to sweep past device 220 in the direction 320 of FIG. 1. As stage 210 moves, or the linear array detector 230 moves longitudinally (or pivots) relative to the device 220 being inspected, the light intensity reflected by each small area of the device being inspected corresponding to a respective detector element is transmitted to the processor 260. In some embodiments, the integration time during which the line array detector 230 collects an individual line of data is selected according to the characteristics of the line array detector 230, the desired signal to noise ratio, or both. The speed of the conveyor 305 (or the speed at which the linear array detector scans each line of the image) is then selected accordingly.

In step 104, lines of data representing a portion of a device being inspected are received from the linear array detector 225. In some embodiments, the number of lines to achieve an image with a desired detail (μm per pixel) is selected by the user.

At step 106, processor 260 generates a sample image of the device 220 on the stage 210 from lines of data received from the linear array detector 230. By adjusting for the relative movement of the linear array detector and the device being inspected, the processor 260 can assemble the lateral lines of data together to generate a two dimensional sample image of the device being inspected with the desired level of image detail (μm per pixel).

The processor 260 pre-processes the sample image in step 108. In some embodiments, pre-processing includes, but is not limited to, cutting (or cropping) the sample image, scaling (or sizing) the sample image, and rotating the sample image so that the sample image can be accurately compared to the reference image. In some embodiments, pre-processing includes rotating the image to ensure that the sample image is properly oriented (so that the principal axes of the sample image are aligned with the principal axes of the reference image). In some embodiments, pre-processing includes scaling or resizing the image, so the size (number of pixels in each direction) of the sample image matches the size of the reference image for further analysis and comparison with the reference image. In some embodiments, pre-processing includes cutting (or cropping) the sample image, to remove extra portions of the device 220 or its surroundings that are present in the sample image but excluded from the reference image. In some embodiments, pre-processing can also include adjusting the overall color (e.g., white balance and tint) of the sample image to that of the reference image to account for color variability between lots or variability in the lighting conditions of the space in which the system 200 is located between images. In some embodiments, pre-processing includes normalizing the luminance levels of the sample image, so that the sample image and reference image have the same black level, white level and dynamic range.

In Step 110, the processor 260 calculates detection parameters of the sample image. In some embodiments, the sample images contain either light intensity by red, green and blue for each pixel, or light intensity by gray scale for each pixel. In some embodiments, the detection parameters are generated by calculating the light intensity for each color for each pixel or group of pixels. In other embodiments, the sample images use an alternative color space (such as cyan-magenta-yellow).

In step 112, the processor 260 compares features of the sample image with features of the reference image. In one example, the reference image is the combination of a number of calibration images captured using the system described above. The calibration images can be random sample images or can be images of devices that have been inspected and deemed of a sufficient quality to be used to generate the reference image or can be any other suitable sub-sets of images. In some embodiments, each of the calibration images is then pre-processed to ensure proper alignment of the devices represented in the images. In some examples, each pixel location of each calibration image is analyzed to obtain a mean light intensity and a standard deviation. Thus, the detection parameters of the reference image being used in the comparison with the sample image can be the mean and standard deviation for each pixel and, as described in more detail below, the comparison can be a pixel-by-pixel comparison between the sample image and the detection parameters of the reference image. In other embodiments, the comparison is made between corresponding groups of pixels (e.g., a 2×2 pixel group, a 4×4 pixel group, or the like).

In some embodiments, the processor 260 uses the result of the comparison to determine whether each pixel is categorized as an “abnormal pixel”. The phrase “abnormal pixel” refers to pixels of the sample image having at least one characteristic that deviates from the characteristic of the corresponding pixels in the reference image by a predetermined amount determined to be indicative of abnormal pixels. For example, in some embodiments, a pixel may be considered an abnormal pixel if the light intensity of that pixel deviates from the mean light intensity of the reference image by a particular amount or particular number of standard deviations.

Following the comparison, in step 114, abnormal features of the sample image are detected and classified. For example, in some embodiments, the abnormal pixels are grouped into sets of adjacent abnormal pixels. As discussed in more detail below, these groups of abnormal pixels can be classified as particular types of abnormal features.

In an embodiment, the processor 260 identifies abnormal features by generating detection parameters from a plurality of calibration images used to produce a reference image. In some embodiments, the detection parameters include, but are not limited to, the mean and standard derivation values calculated for each pixel position in the calibration images. Using this information, a detecting rule can be set up based on the detection parameters. For example, in some embodiments, the detecting rule is that the light intensity of each pixel of the sample image falls within the range of the mean value plus or minus three times of the standard derivation of the equivalently located pixel in the reference image. If some pixels of the inspected image have a light intensity that falls outside of the detecting rule, the pixel itself is designated as “abnormal.” In some embodiments, once the abnormal pixels are identified from a sample image, the abnormal pixels are sorted into sets of adjacent abnormal pixels. In some embodiments, each group of abnormal pixels, referred as an abnormal feature, or a defect, is analyzed to determine a defect type based on the properties of the individual abnormal pixel group (e.g., shape of pixel group, aspect ratio of the pixel group, level of light intensity deviation, etc.).

In step 116, the user (or the processor 260) updates the detection parameters for the sample image to improve accuracy of the quality analysis. In some embodiments, the sample image used as a calibration image and the detection parameters of the reference image are recalculated with the sample image used as a new or additional calibration image.

In step 118 the processor 260 determines whether the device 220 passes inspection. For example, a device 220 can pass inspection if it meets a predefined quality control threshold. In some embodiments, the predefined quality control threshold includes a threshold that includes, but is not limited to, specifying that fewer than a specified number or percentage of defects (abnormal pixels or features) are acceptable, specifying an absence of specific types of defects, or a combination of both.

In some embodiments, the entire sequence including steps 100-118 is repeated multiple times for multiple devices 220 or device lots. In such embodiments, the method also can include removing the device 220 from the stage 210 automatically and providing a second device 220 or device lot on the stage, so the process can be repeated with the second device. Additional details of this process will be evident from the following discussion of FIGS. 2 through 7, which include FIGS. 3 through 6, which show examples of sample images with highlighted areas 330 that include a defect.

In some embodiments, the system 200 compares individual pixels of the sample image with the detection parameters of the corresponding pixel from the reference image. For example, in some embodiments, the light intensity of a pixel at a given position in the sample image is compared with the mean light intensity of the pixel in the same position on the reference image. In some embodiments, if the sample image pixel's light intensity deviates from the mean light intensity of the corresponding pixel from the reference image by more than a specified amount (e.g., by 2 standard deviations, by 3 standard deviations, etc.), the pixel of the sample image is deemed abnormal. This analysis is conducted on a pixel-by-pixel basis over the relevant area of the sample image.

In some embodiments, the sample image is modified by highlighting pixels that are deemed abnormal by the system. The processor 260 causes display 280 to show a representation of the sample image 290 with an indication of the abnormal pixels. For example, in some embodiments, the display 280 can insert a box around the detected abnormal pixels.

In some embodiments, the system and method is adapted for generating a reference image and/or detection parameters by combining at least three images of devices meeting a quality control threshold.

In some embodiments, the linear array detector 230 is used to generate a plurality of sample images. In some embodiments, the sample images are rotated and/or translated to ensure that the sample section in the images are orthogonal to each other, and the inspected sample section in the rotated sample images are cut. Then, the images are aligned to each other and stacked together pixel by pixel to create a reference image. Examples of suitable software packages for performing the image processing steps described herein include, but are not limited to, MATLAB available from MathWorks, and HALCON available from MVTec Software GmbH.

Increasing the number of images used to generate the reference image increases the likelihood that the reference image is representative of an ideal device, and that a sharp reference image with good quality can be obtained. Thus, in some embodiments, at least five images (˜84% likelihood) or at least seven images (˜90% likelihood) or at least nine images (˜92% likelihood) can be combined to produce the reference image. In some examples, the calibration images used to generate the reference image are sample images of one or more devices that pass inspection. In some embodiments, the reference image is obtained by averaging (e.g., mean) the light intensity values for each pixel position on a pixel-by-pixel basis.

The system and method can be adapted for classifying each abnormal feature by a type of defect according to a predetermined classification system. In some embodiments, the predetermined classification system relies on defect classifications that include, but are not limited to, feature area, feature aspect ratio, RGB color, feature position, boundary region length, roundness of feature, major axis length and minor axis length.

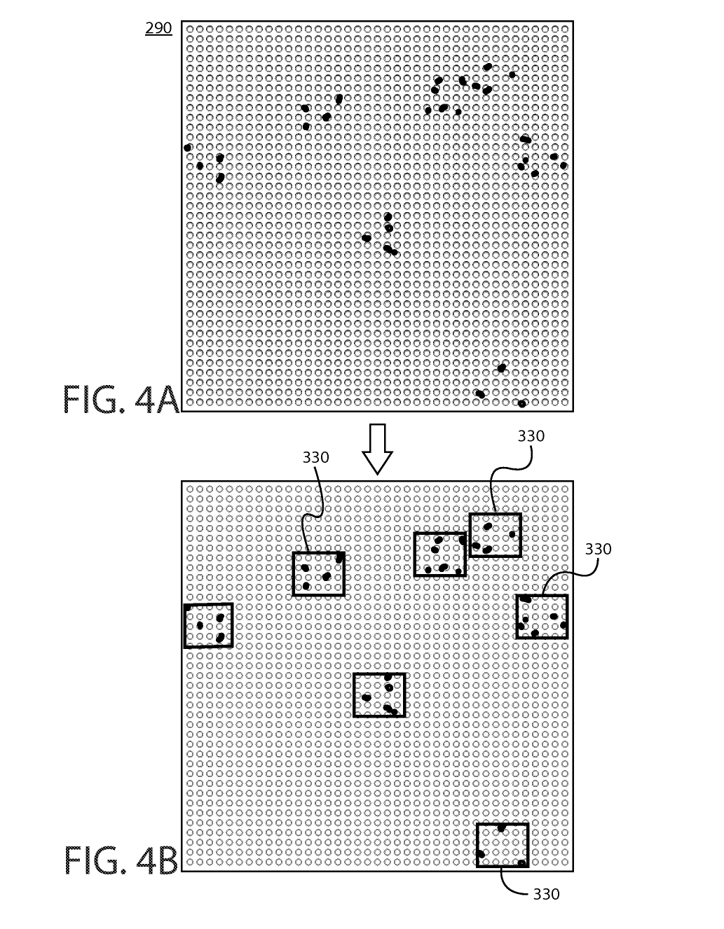

In some embodiments, the structure of the device being inspected is selected from the group that includes, but is not limited to, a ball grid array and a printed circuit board substrate. FIG. 3A shows an example of a sample image of a printed circuit board with defects shown as dark spots. FIG. 3B shows the same sample image with groups of abnormal pixels in highlighted areas 330. Similarly, FIG. 4A shows examples of a sample image of a ball grid array with defects shown as dark lines, while FIG. 4B shows the same sample image with groups of abnormal pixels in highlighted areas 330. The systems described herein are not limited to inspection of the devices discussed herein, and can be used for inspecting other devices including devices that include other structures.

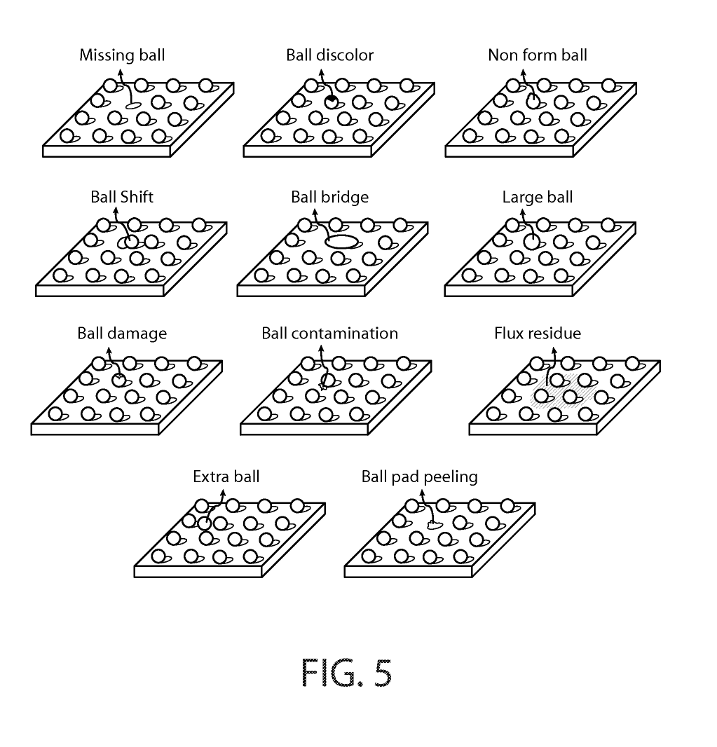

FIG. 5 shows a variety of ball defects where the structure being inspected is a ball grid array. Examples of ball defects include, but are not limited to, missing balls, ball discoloration, deformed (improperly formed) balls, ball shifting, ball bridges, small/large balls, ball damage (after ball formation), ball contamination, ball flux residue, ball pad peeling and extra balls.

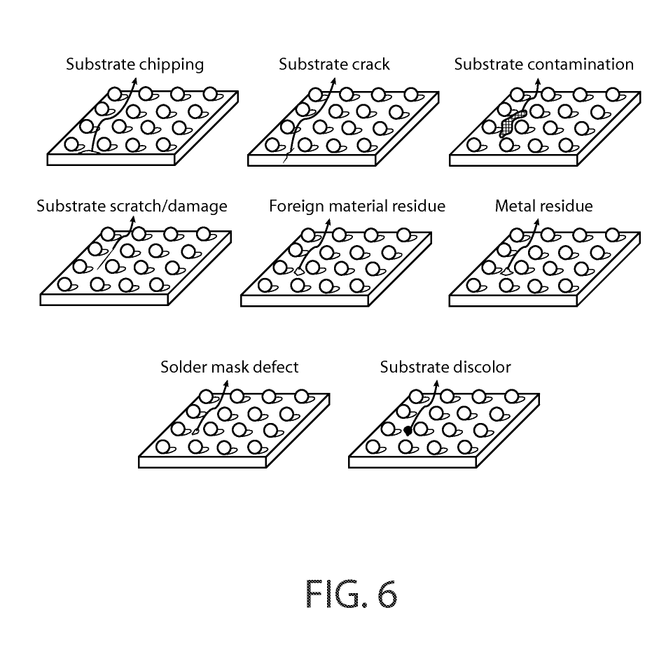

FIG. 6 shows a variety of substrate defects in a ball grid array, which may be equally applicable to a printed circuit board substrate. Examples of substrate defects, include but are not limited to, substrate chipping, substrate cracking, substrate contamination/impurities, substrate scratch/damage, foreign material residue, metal residue, solder mask defects, and substrate discoloration.

The system and method can also be adapted for inputting a type of structure being inspected; and automatically selecting the reference image based on the structure being inspected. For example, the user can enter the type of structure being inspected and, based on the user input (or default setting), the processor 260 can select the reference image and detection parameters for that type of structure from the computer readable storage 270. In some embodiments, the plurality of features of the sample image can be identified based on detection parameters specific to the type of structure being inspected.

In some embodiments, the detecting step includes calculating image parameters for the sample image using defect detection parameters. In one example, once adjacent groups of abnormal pixels have been identified, image parameters are calculated from the groups of abnormal pixels (possible defect areas). The parameters include, but are not limited to, size, color, major/minor axis length, aspect ratio, etc., of each group of abnormal pixels. Each type of defect can be identified by one or more parameters having specific ranges or values. Thus, by comparing the parameters of a specific group of abnormal pixels, the groups of abnormal defects can be sorted by their features to identify the defect type.

In some embodiments, the device and method includes updating the reference image. In some embodiments, the reference image is updated to include the sample image. For instance, in some embodiments, the reference image and detection parameters are updated automatically or manually to prevent incorrect identification of defects.

In some embodiments, the processor 260 performs a comparison to check whether the reference image is defect free. This technique can be used to prevent two or more sample images from having the same defect in the same position. In this situation, the created reference image may have the defect in it. In the comparison technique, the system chooses an area at a position in the reference image, to calculate the average light intensity value. The system also chooses neighborhood areas to calculate the average light intensity values. If the calculated average light intensity value of the selected area is different from the values of neighborhood intensity values, the system will recognize the selected area in the reference image as “abnormal” or “irregular” and highlight this area. Then, the system will issue an alarm or notification, and request the engineer to review the correction of the reference image.

As is apparent, the processor 260 analyzes a large number of variations and defects, so some embodiments will include adjusting the defect inspecting criteria (e.g., detection parameters) and judgment thresholds. In some embodiments, the user or the processor adjusts the defect inspecting criteria and judgment thresholds as additional quality control information becomes available. In some examples, the processor automatically adjusts the relevant detection parameter targets, ranges, or both, using an algorithm to select sample images with minimal abnormal pixels and/or abnormal features. In other examples, the adjusting is called fine tuning and is done manually, where the operator selects sample images with minimal abnormal pixels and/or abnormal features.

As will be understood, the embodiments described herein can be combined in any appropriate manner in order to produce a quality control inspection method and system.

The line array detector camera (LAC) 230 described herein produces higher resolution images across a wider field of view while minimizing cross-tone interference resulting from the electric signals generated from the neighborhood detectors in an area array camera (AAC) due to small gaps between adjacent detectors. While an AAC creates cross-tone interference in two dimensions, cross-tone interference is minimized or eliminated in the one dimensional LAC device, which further improves resolution for the abnormal pixel/feature analysis techniques described herein. In addition, while an AAC device may have 5,000 pixels in each of two dimension, an LAC device can have 16,000 (or 12,000 or 8,000) pixels in a single dimensions and the image detail (μm per pixel) in the perpendicular dimension can be controlled by controlling the relative rate of movement of the LAC device and the stage, or by the sampling rate, and the number of lines of image data collected. Thus, while an AAC with 130 pixels in each dimension can produce an image with 16,900 pixels (130 pixels×130 pixels=16,900 pixels), an image 130 pixels tall generated with a 5,000 pixel LAC device will have 650,000 pixels over the same area. An additional advantage over AAC devices is that an LAC device allows for a continuous process.

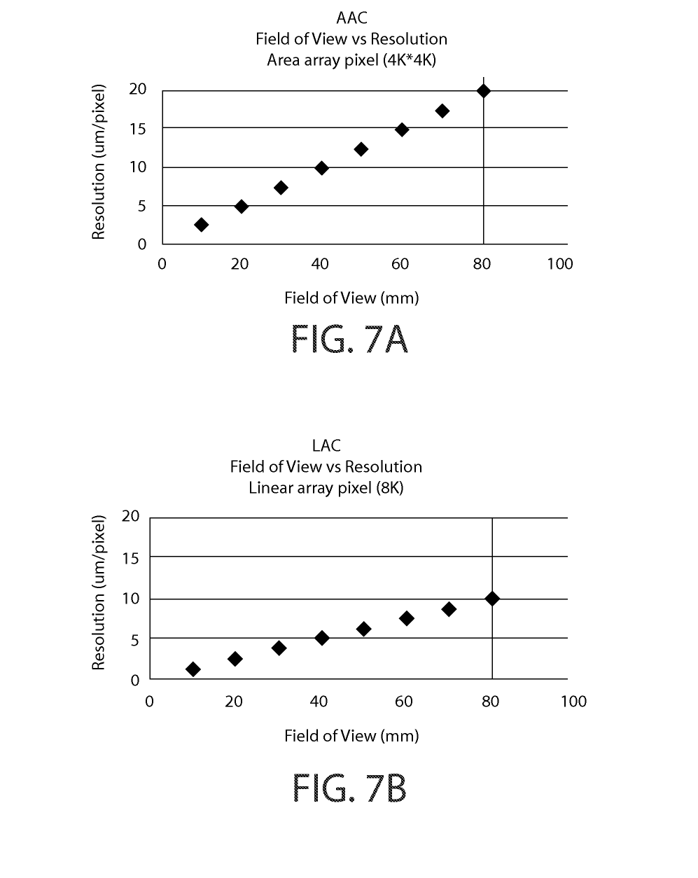

Current semiconductor packages are becoming more and more intricate due to 3D-integrated circuit stacking. In some cases, the size of the package is also increasing so that multiple functional dies can be packaged together, e.g., side-by-side on an interposer in a 2.5D configuration. Thus, both high resolution and a broad field of view are useful for accurate inspection of these highly complex packages. The system described herein reduces the trade-off of image detail (measured by μm/pixel) versus field of view and produce a superior inspection tool by producing a system with both a wide field of view and a high level of image detail. The improvement of the linear array camera over an area array camera is shown in FIGS. 7A & B, respectively, which show image detail (measured by μm/pixel) versus field of view for an AAC system and a LAC system, respectively. As an example, as shown in FIG. 7A, a 4,000 by 4,000 pixel AAC device (160,000 total pixels) provides image detail of 20 μm/pixel for an 80 mm field of view, whereas FIG. 7B shows that an 8,000 pixel LAC device provides double the level of image detail (10 μm/pixel) for the same 80 mm field of view.

Some embodiments include a quality assurance system that in turn includes a stage configured to support a device; a detector array spaced apart from the stage; a drive for moving the stage, the detector array or both, relative to one another; and a processor operatively connected to the detector array. The detector array is configured to generate a line of data representing light reflected from the device. The processor is programmed to generate a sample image of the device on the stage from lines of data received from the detector array; compare a plurality of features of the sample image to a corresponding plurality of features of a reference image; and detect features in the sample image deviating from corresponding features of the reference image based on the comparison.

In some embodiments, the processor comprises circuitry for pre-processing the sample image prior to making the comparison.

In some embodiments, the processor comprises circuitry for classifying each deviating feature by a type of defect according to a predetermined classification system. In some embodiments, the predetermined classification system includes defect classifications selected from feature area, feature aspect ratio, RGB color, feature position, boundary region length, roundness of feature, major axis length and minor axis length.

In some embodiments, the system also includes a computer readable storage medium operably connected to the processor, wherein the storage medium stores the reference image.

In some embodiments, the processor comprises imaging circuitry for creating an output image comprising the sample image with a highlighted area comprising a defect.

In some embodiments, the detector array is a linear detector array.

In another form of the present disclosure, a method of inspecting a structure of a device is described. The method includes generating a sample image of a device having a structure to be inspected; identifying a plurality of features of the sample image; comparing the plurality of features to a corresponding plurality of features of a reference image; and locating features in the sample image that deviate from corresponding features of the reference image. The generating comprises moving the device, a detector array or both, relative to one another, wherein the detector array is configured to generate a line of data representing light reflected from the device; and assembling lines of data from the detector array to generate the sample image.

In some embodiments, the moving comprises positioning the device on a moveable stage, and moving the stage relative to the detector array.

In some embodiments, the method also includes generating a reference image by combining at least three images of devices meeting a quality control threshold.

In some embodiments, the generating step also includes pre-processing the sample image prior to the comparing step.

In some embodiments, the method also includes classifying each deviating feature by a type of defect according to a predetermined classification system. In some embodiments, the predetermined classification system includes defect classifications selected from the group consisting of feature area, feature aspect ratio, RGB color, feature position, boundary region length, roundness of feature, major axis length and minor axis length.

In some embodiments, the structure of the device being inspected is selected from the group consisting of a printed circuit board substrate or a ball grid array.

In some embodiments, the method also includes inputting a type of structure being inspected; and selecting the reference image based on the structure being inspected. In some embodiments, the plurality of features of the sample image are identified based on defect detection parameters specific to the type of structure being inspected.

In some embodiments, the identifying comprises calculating image parameters for the sample image using defect detection parameters. In some embodiments, the method also includes updating the detection parameters based on analysis of the sample image.

In some embodiments, the detector array is a linear detector array.

In another broad form of the present disclosure, a method of inspecting a device having a plurality of structures is described. The method includes generating a sample image of a device having a plurality of structures to be inspected; identifying a plurality of features of the sample image; comparing the plurality of features to a corresponding plurality of features of a reference image; locating features in the sample image that deviate from corresponding features of the reference image; and determining whether or not the device meets a predefined quality control threshold. The sample image is generated by moving the device, a detector array or both, relative to one another, wherein the detector array is configured to generate a line of data representing light reflected from the device; and assembling lines of data from the detector array to generate a sample image. The identifying step comprises calculating image parameters for the sample image the defect detection parameters specific to the type of structure being inspected.

The preceding merely illustrates the principles of the disclosure. It will thus be appreciated that those of ordinary skill in the art will be able to devise various arrangements which, although not explicitly described or shown herein, embody the principles of the disclosure and are included within its spirit and scope. Furthermore, all examples and conditional language recited herein are principally intended expressly to be only for pedagogical purposes and to aid the reader in understanding the principles of the disclosure and the inventive concepts, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

This description of the exemplary embodiments is set to be understood in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the disclosure has been described in terms of exemplary embodiments, it is not limited thereto. Rather, the appended claims should be construed broadly, to include other variants and embodiments of the disclosure, which may be made by those of ordinary skill in the art without departing from the scope and range of equivalents of the disclosure.

What is claimed is:

1. A quality assurance system, comprising:
a stage configured to support a device;
a detector array spaced apart from said stage, the detector array configured to generate a line of data representing light reflected from the device;
a drive configured to move said stage, said detector array or both relative to one another;
a processor operatively connected to said detector array, wherein said processor is programmed to:
generate a sample image of the device on said stage from lines of data received from said detector array,
compare a plurality of features of said sample image to a corresponding plurality of features of a reference image, and
detect features in said sample image deviating from corresponding features of the reference image based on the comparison.

2. The quality assurance system as in claim 1, wherein said processor comprises circuitry for pre-processing said sample image prior to making said comparison.

3. The quality assurance system as in claim 1, wherein said processor comprises circuitry for classifying each deviating feature by a type of defect according to a predetermined classification system.

4. The quality assurance system as in claim 3, wherein said predetermined classification system includes defect classifications selected from the group consisting of feature area, feature aspect ratio, RGB color, feature position, boundary region length, roundness of feature, major axis length and minor axis length.

5. The quality assurance system as in claim 1, further comprising a computer readable storage medium operably connected to said processor, wherein said storage medium stores said reference image.

6. The quality assurance system as in claim 1, wherein said processor comprises imaging circuitry for creating an output image comprising said sample image with a highlighted area comprising a defect.

7. The quality assurance system as in claim 1, wherein said detector array is a linear detector array.

8. A method of inspecting a structure of a device, comprising:
generating a sample image of a device having a structure to be inspected, wherein said generating comprises:
moving said device, a detector array or both, relative to one another, wherein the detector array is configured to generate a line of data representing light reflected from the device, and
assembling lines of data from said detector array to generate a sample image;
identifying a plurality of features of said sample image;
comparing said plurality of features to a corresponding plurality of features of a reference image; and
locating features in said sample image that deviate from corresponding features of the reference image.

9. The inspecting method as in claim 8, wherein said moving comprises:
positioning the device on a moveable stage, and
moving the stage relative to the detector array.

10. The inspecting method as in claim 8, wherein said method further comprises:
generating a reference image by combining at least three images of devices meeting a quality control threshold.

11. The inspecting method as in claim 8, wherein said generating step, further comprises:
pre-processing said sample image prior to said comparing step.

12. The inspecting method as in claim 8, further comprising:
classifying each deviating feature by a type of defect according to a predetermined classification system.

13. The inspecting method as in claim 12, wherein said predetermined classification system includes defect classifications selected from the group consisting of feature area, feature aspect ratio, RGB color, feature position, boundary region length, roundness of feature, major axis length and minor axis length.

14. The method as in claim 8, wherein the structure of the device being inspected is selected from the group consisting of a printed circuit board substrate or a ball grid array.

15. The inspecting method as in claim 8, further comprising:
inputting a type of structure being inspected; and
selecting said reference image based on said structure being inspected.

16. The inspecting method as in claim 15, wherein said plurality of features of said sample image are identified based on defect detection parameters specific to said type of structure being inspected.

17. The inspecting method as in claim 8, wherein said identifying comprises calculating image parameters for said sample image using defect detection parameters.

18. The inspecting method as in claim 17, further comprising:
updating said detection parameters based on analysis of said sample image.

19. The inspecting method as in claim 8, wherein said detector array is a linear detector array.

20. A method of inspecting a device having a plurality of structures, comprising:
generating a sample image of a device having a plurality of structures to be inspected, wherein said generating comprises:
moving said device, a detector array or both, relative to one another, wherein the detector array is configured to generate a line of data representing light reflected from the device, and
assembling lines of data from said detector array to generate a sample image;
identifying a plurality of features of said sample image;
comparing said plurality of features to a corresponding plurality of features of a reference image;
locating features in said sample image that deviate from corresponding features of the reference image; and
determining whether or not said device meets a predefined quality control threshold, wherein said identifying comprises calculating image parameters for said sample image using defect detection parameters specific to said type of structure being inspected.
